(19) United States
(12) Patent Application Publication
(10) Pub. No.: US 2010/0223073 A1
(43) Pub. Date: Sep. 2, 2010

(54) DYNAMIC MEDICAL COMMUNICATION SYSTEMS AND METHODS

(75) Inventors: Howard S. Nearman, Pepper Pike, OH (US); Donald M. Voltz, Twinsburg, OH (US); Alon S. Aharon, Scarsdale, NY (US)

Correspondence Address: TUROCY & WATSON, LLP, 127 Public Square, 57th Floor, Key Tower, CLEVELAND, OH, 44114, US

(73) Assignees: NVA MEDICAL TECHNOLOGIES, LLC, Pepper Pike, OH (US); TUROCY & WATSON, LLP, Cleveland, OH (US)

(21) Appl. No.: 12/714,940

(22) Filed: Mar. 1, 2010

Related U.S. Application Data
(60) Provisional application No. 61/156,671, filed on Mar. 2, 2009.

(51) Int. Cl. G06Q 50/00; G06Q 10/00; G06F 15/16; H04L 9/00

(52) U.S. Cl. 705/3; 709/206; 380/255

(57) ABSTRACT

The claimed subject matter provides systems and/or methods that facilitate disseminating patient related messages as part of a dynamic medical communication environment. A server can receive patient related messages from one or more message source components. Further, the server can broadcast the patient related messages to one or more subscription components as a function of identities of patients respectively corresponding to the patient related messages. Patients can be registered as object to which one or more subscription components can subscribe. Subscription components can automatically, manually, etc. subscribe to registered patients to receive message streams pertaining thereto. Moreover, a registered patient corresponding to a received patient related message can be identified, subscription components subscribed to the identified patient can be recognized, and the message can be broadcast to the recognized subscription components.

### CROSS-REFERENCE TO RELATED APPLICATION

This application claims the benefit of U.S. Provisional Patent Application Ser. No. 61/156,671 entitled “DYNAMIC MEDICAL COMMUNICATION SYSTEMS AND METHODS” which was filed Mar. 2, 2009. The entirety of the aforementioned application is herein incorporated by reference.

### BACKGROUND

When focusing on improvement of communication within the healthcare setting, the Joint Commission on Accreditation of Healthcare Organizations (JCAHO) found inadequate communication as a significant common root cause of medical errors across medical specialties and involving healthcare providers at all levels. For hospitals, the handoff has long been the Bermuda Triangle of healthcare: dangerous errors and oversights can occur in the gap when a patient is moved to another unit, turned over to a new nurse or doctor during a shift change, and the like. Now, with growing evidence that communication breakdowns during such transfers are a prominent source of medical error, the Joint Commission on Accreditation of Healthcare Organizations is requiring hospitals for the first time to establish standards for handoff communications and breaking down longstanding cultural barriers in the exchange of patient information between doctors and nurses.

Handoffs involve the transfer of rights, duties, and obligations from one person or team to another. In medicine, wide variation exists in handoffs of hospitalized patients from one physician or team to another. Hospitals generally have some handoff procedures, but they tend to be ad-hoc arrangements that vary from unit to unit or even nurse to nurse. Many hospitals have begun to implement new checklists, forms and routines that will formalize these structures. Numerous improvement projects have been implemented in an attempt to reduce this significant and serious problem. However, there is no standardization of these protocols, most likely because none have been shown to be very effective.

There are three primary modes of communication within and between healthcare providers. These are direct face-to-face communication, use of paging/text messaging, or the use of the medical record (e.g., the conventional paper based record, the evolving electronic medical record (EMR), . . . ). These modes of communication are utilized for two primary reasons within the care of a patient: communication of patient specific data (e.g., lab results, vital signs, consultant feedback pertaining to a specific problem, change in status of a patient, . . . ) and communication of a treatment path or decision branch point. The primary methods of communication and the transference of information between healthcare providers tend to be unilateral and occur in small pieces. To enhance patient care, reduce medical errors, and shorten both costs and hospital length of stay, one typically integrates these small pieces of data and communicate the plan of actions based on this information to the entire healthcare team involved with a given patient. In any situation, numerous physicians, nurses, and specialized healthcare providers are intimately involved with and impact the care of a patient. Keeping the critical players informed with the patient specific information is challenging given the current communication structure present in healthcare today. While there is no debating the importance of communication in the delivery of safe, effective patient care, a solution that clearly addresses these issues has not yet been adopted.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The claimed subject matter relates to systems and/or methods that facilitate disseminating patient related messages as part of a dynamic medical communication environment. A server can receive patient related messages from one or more message source components. Further, the server can broadcast the patient related messages to one or more subscription components as a function of identities of patients respectively corresponding to the patient related messages. Patients can be registered as object to which one or more subscription components can subscribe. Subscription components can automatically, manually, etc. subscribe to registered patients to receive message streams pertaining thereto. Moreover, a registered patient corresponding to a received patient related message can be identified, subscription components subscribed to the identified patient can be recognized, and the message can be broadcast to the recognized subscription components.

The following description and the annexed drawings set forth in detail certain illustrative aspects of the claimed subject matter. These aspects are indicative, however, of but a few of the various ways in which the principles of such matter may be employed and the claimed subject matter is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a block diagram of an example dynamic communication system that distributes patient related messages within a healthcare setting.

FIG. 2 illustrates a block diagram of an example system that implements dynamic medical communication in accordance with various aspects of the claimed subject matter.

FIG. 3 illustrates an example graphical user interface (GUI) that can be employed with the dynamic medical communication techniques described herein.

FIG. 4 illustrates an example scenario that can result within the current healthcare setting without dynamic medical communication as described herein.

FIG. 5 illustrates an example scenario that can yield a different outcome as compared to traditional techniques using dynamic medical communication.

FIG. 6 illustrates an example graphical user interface that can be leveraged in an operating room with the dynamic medical communication techniques described herein.

FIG. 7 illustrates example data input modes that can be used for data entry into a dynamic medical communicator database.

FIG. 8 illustrates a block diagram of an example system that incorporates dynamic medical communication.

FIG. 9 illustrates a block diagram of an example system that provides dynamic, distributive, web-based communication for use in a healthcare setting.

FIG. 10 illustrates an example methodology that facilitates initializing a patient within a dynamic medical communication environment.

FIG. 11 illustrates an example methodology that facilitates publishing patient related messages within a dynamic medical communication environment.

FIG. 12 illustrates an exemplary networking environment, wherein the novel aspects of the claimed subject matter can be employed.

FIG. 13 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, . . . ), optical disks (e.g., compact disk (CD), digital versatile disk (DVD), . . . ), smart cards, and flash memory devices (e.g., card, stick, key drive, . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

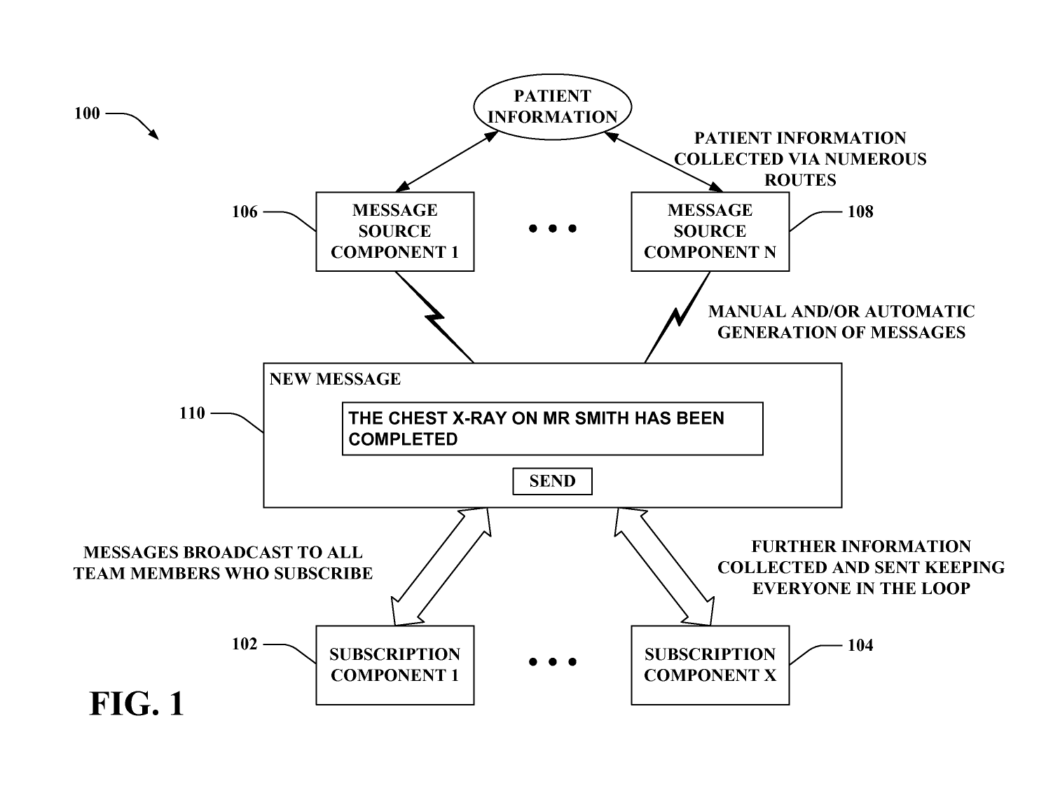

Now turning to the figures, FIG. 1 illustrates an example dynamic communication system 100 that distributes patient related messages within a healthcare setting. The system 100 can be utilized to mitigate errors commonly encountered to date that oftentimes arise due to incomplete, inaccurate, etc. distribution of patient related information, particularly during a handoff scenario. Accordingly, the system 100 can be leveraged to integrate the care and communication a patient receives in the complex healthcare setting.

The system 100 can include any number of subscription components (e.g., subscription component 1 102, . . . , subscription component X 104, where X can be substantially any integer, . . . ). The subscription components 102-104, for instance, can be devices, accounts, a combination thereof, and so forth. Moreover, the subscription components 102-104 can each be associated with a respective subscriber (or group of subscribers). The subscribers can be, but are not limited to, primary physicians, consulting physicians, floor and ICU nurses, bed control nurses, nurse managers, resident physicians, medical and paramedical students, laboratory services, emergency services, physical therapy/occupational therapy, pharmacy services, dietary services, patients, patients' families/family members, hospital billing personnel, research (data collection) technicians, and so forth. By way of illustration, subscription component 1 102 can be an account (and/or associated device(s)) corresponding to a primary physician and subscription component X 104 can be an account (and/or associated device(s)) corresponding to a nurse; it is to be appreciated, however, that the claimed subject matter is not so limited. Further, characteristics such as the role of the corresponding subscriber(s) (e.g., primary physician, nurse, laboratory technician, patient, . . . ), the device(s) employed by the corresponding subscriber(s), criteria associated with such device(s), permissions assigned to the corresponding subscriber(s), preferences of the corresponding subscriber(s), and the like can be associated with each of the accounts.

Each of the subscription components 102-104 can subscribe to one or more patients, and each patient can be subscribed to by one or more subscription components (e.g., subscription components 102-104, any disparate subscription component(s) (not shown), . . . ). Thus, a patient can be treated as an object, which is available for subscription. In the depicted example, subscription components 102-104 can be subscribed to a patient named Mr. Smith; it is to be appreciated, however, that the claimed subject matter is not so limited. Moreover, although not shown, it is contemplated that any number of disparate subscription components (not illustrated) can be included in the system 100, but need not be subscribed to this patient (Mr. Smith).

The system 100 can also include any number of message source components (e.g., message source component 1 106, . . . , message source component N 108, where N can be substantially any integer, . . . ). According to an illustration, the message source components 106-108 can include the subscription components 102-104 (or a subset thereof). Following this illustration, a nurse can be associated with an account (e.g., subscription component 1 102, . . . ), which is subscribed to a patient; this nurse can employ his account to send patient related message(s) (e.g., the account can be the message source component 1 106, . . . ). Pursuant to a further example, the message source components 106-108 can include device(s), user(s), account(s), and the like that need not be subscribed to the patient that is the subject of a generated message. According to this example, an electrocardiogram (ECG) device can be a message source component (e.g., the message source component 1 106, . . . ), which generates a message related to the patient; however, the ECG device need not be subscribed to the patient, and thus, need not receive messages pertaining to the patient. Yet, the claimed subject matter is not so limited as it is to be appreciated that the ECG device (or any other device(s), equipment, etc.) can be subscribed to the patient.

The message source components 106-108 can collect patient information via numerous routes. For instance, the message source components 106-108 can obtain patient information automatically, manually, a combination thereof, and so forth. Moreover, the message source components 106-108 can automatically and/or manually generate patient related messages. Each of the patient related messages can thereafter be broadcast to the subscription components 102-104 that subscribe to the given patient associated therewith. Thus, members of a medical team can subscribe to a particular patient, and when a message that includes information pertaining to the particular patient is generated, such message can be broadcast to all subscribed team members. Hence, as further information is collected, it can be sent to all subscribing subscription components 102-104, thereby notifying all of the subscribers.

According to an illustration, the message source 1 106 can generate new message 110 related to a particular patient, Mr. Smith. The new message 110 can thereafter be broadcast to the subscription components 102-104, each of which are subscribed to this particular patient. Accordingly, subscribers associated with each of the subscription components 102-104 can be presented with the new message 110, thereby reducing mistakes, errors, or the like that typically are resultant from communication breakdown, which can be particularly problematic during handoff.

Technology continues to make its way into the clinical setting. The nationwide embracing of the electronic medical record and its slow adoption is beginning to be seen. This allows for a centralized storage of the huge amount of information and data collected on every patient who enters the system. It may be many years before standardized systems are adopted to allow for smooth communication of disparate information between healthcare systems and ultimately across the country. Despite the advances made in the electronic capture of medical information, communication of this information continues to be a problem with many healthcare providers accessing and using specific pieces of data without widespread communication of this information to others on the healthcare team. Non-clinical personnel such as medical coders, billing, bed allocation specialists, or hospital administration also do not directly share real time data needed to promote efficiency in their particulars arenas.

There are a number of limitations to the communication that occurs currently. Clinical information from the front-lines (e.g., nurses at the bedside, . . . ) involves collection of relevant patient-specific data such as blood work or vital sign information. When there are specific changes in these values or concerns that develop on the hospital floor, the nurse typically will page, or in some settings text message, the physician who is responsible for the patient. The responsible physician at that point in time may not be the patient's primary physician, but instead may be someone who is covering for that physician. Furthermore, there may be a change in shift for a given provider setting up another potential area for communication error. The information that is passed from the nurse to the physician, or from any other healthcare provider is often lost after the interaction. Often the physician or healthcare provider who is faced with making a clinical decision can require a larger context before the most appropriate therapy or choice can be made. This involves “pulling” of information out of the system, be it a paper record or an electronic one, often requiring paging through multiple documents that can be located in numerous areas throughout the hospital. In addition, other tests or studies that would help make a more informed decision may not have been completed (or their results not yet placed in the central medical record), necessitating further phone calls or the engagement of other healthcare providers to collect the pertinent information. This leads to a very inefficient and error prone system.

The establishment of a “push” system of medical communication coupled with a system that continually queries for newly added information as described herein can greatly impact healthcare as currently delivered. In addition to providing relevant information to a specific healthcare provider, the system 100 can broadcast any changes in patient information or decisions that were made to anyone on the healthcare team involved with this patient using a subscriber model.

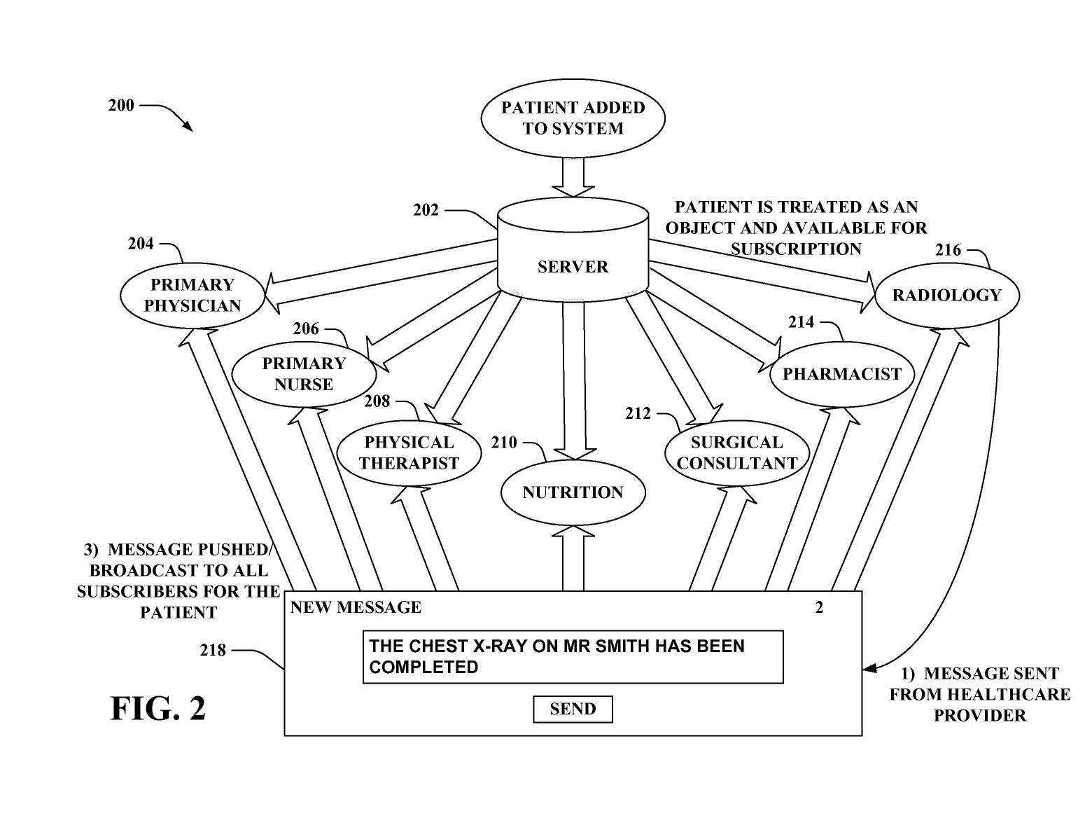

Turning to FIG. 2, illustrated is an example system 200 that implements dynamic medical communication in accordance with various aspects of the claimed subject matter. The system 200 includes a server 202. Although one server 202 is depicted, it is to be appreciated that the system 200 can include substantially any number of servers, each of which can be substantially similar to the server 202.

As depicted, a patient can be registered with the system 200. For instance, a patient can be enrolled with the server 202 (e.g., included in a database retained in data store associated with the server 202, . . . ). It is contemplated that registration can be effectuated in substantially any manner. By way of illustration, a patient can be registered in the system 200 by way of manual entry. Additionally or alternatively, a patient can be registered in the system 200 by integration with a patient management system (not shown) of a hospital. Further, the patient can be treated as an object. Moreover, one or more subscription components (e.g., subscription components 102-104 of FIG. 1, . . . ) can subscribe to the patient (e.g., subsequent to the patient enlisting in the system 200, . . . ).

The data store associated with the server 202 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store of the subject systems and methods is intended to comprise, without being limited to, these and any other suitable types of memory. In addition, it is to be appreciated that the data store can be a server, a database, a hard drive, and the like.

Members of a healthcare team (e.g., subscribers 204-216, . . . ) can subscribe to patient(s) with which each is respectively involved. Patient(s) can be added to an account associated with a subscription component (and/or the subscription component can be an account), and thus, a corresponding subscriber 204-216 (e.g., healthcare provider, patient, patient's family member, . . . ), by substantially any manner. For instance, patient(s) can be added to an account by individual selection. According to another example, patient(s) can be included in an account as a group by physician (e.g., patients admitted under a particular physician, . . . ). Additionally or alternatively, patient(s) can be included in an account as a group by service. Further, patient(s) can be associated with an account by assignment (e.g., nurse's current patient load, . . . ). Moreover, patient(s) can be added to an account by location (e.g., patients in Ward 2b, . . . ). By way of another illustration, patient(s) can be added to an account by procedure (e.g., patient(s) with a certain lab, x-ray data, or the like, . . . ). Further, patient(s) can be associated with an account based upon device (e.g., patients with a particular implant, . . . ). It is to be appreciated, however, that the claimed subject matter is not limited to the foregoing examples, and instead, contemplate adding patients to accounts by substantially any manner.

As illustrated in the example of FIG. 2, various healthcare providers (e.g., primary physician 204, primary nurse 206, physical therapist 208, nutrition 210, surgical consultant 212, pharmacist 214, radiology 216, . . . ) can subscribe to a patient registered with the server 202. These healthcare providers 204-216, for instance, can each be associated with respective subscription components (e.g., respective accounts, . . . ).

Following the depicted example of FIG. 2, a patient related message can be sent from a healthcare provider (e.g., radiology 216, . . . ). The sending healthcare provider (e.g., radiology 216, . . . ), for instance, can transmit the message via a message source component (e.g., one or more of the message source components 106-108 of FIG. 1, . . . ). Further, a message 218 can be generated. Thereafter, the message 218 can be pushed/broadcast to all subscribers 204-216 for the patient. Although not shown, it is contemplated that the message 218 can be sent from the message source component associated with the sending healthcare provider (e.g., radiology 216, . . . ) to the server 202. The server 202 can recognize the patient corresponding to the message 218. Further, the server 202 can identify subscription component(s) (e.g., account(s), . . . ) subscribed to the recognized patient. Thereafter, the server 202 can disseminate the message 218 to the identified subscription component(s).

By utilizing the system 200, as information builds, everyone on the team can be kept informed as to the status of the patient. In addition, healthcare team members can join the subscription and publication stream at any time being updated to the plan and pending events for each patient. Thus, the claimed subject matter addresses medical errors due to lack of communication and the transfer of care between healthcare team members.

The dynamic medical communicator as described herein can be utilized to cover the entire healthcare arena. All healthcare workers can utilize this system 200 to help improve patient satisfaction, reduce errors in delivery of patient care, and make the healthcare process more efficient by eliminating duplication of services and enhancing communication among a diverse and far-reaching collection of healthcare workers.

The dynamic communication process can be effectuated as described below. The primary modes of communication in the current healthcare system are either oral communication between individuals or care teams, written communication in a paper or electronic medical records, or the use of pagers/text messages to inquire about some information. In order to stay in touch with the care and status of patient-specific events such as pending lab results, data collected from healthcare team members (e.g., nursing, therapy, dietary, . . . ), and the scheduling and organization of appointments, one needs to proactively seek out the information from another provider or the medical record, if it happens to be written down. This can be frustrating, labor intensive and inefficient. For instance, traditional techniques utilized in the healthcare field to obtain information can be referred to as “pull” techniques. In other words, the healthcare team member commonly must pull the information out of the system, be it the medical records, the laboratory computer, or directly from a healthcare member directly involved with that component of patient care. In addition, if this traditional technique is utilized to gather patient information, the healthcare provider who seeks out the information is usually the only one who knows the information; this healthcare provider then can further communicate it to other team members verbally or in the medical record. This layer of seeking and redistributing information is fraught with potential for errors including, for instance, misunderstanding by other members or the team or forgetting to follow up upon some piece of information.

The dynamic medical communication system 200 can overcome the aforementioned communication problems. Instead of having healthcare team members individually seeking out the information about their patients, these team members are able to subscribe to the patients they are responsible for and the system 200 can “push” the information to them when it becomes available. Described herein are numerous examples related to incorporating the dynamic, distributed, web-based communication technology into the current healthcare system. The information portrayed in these examples, however, is not meant to be inclusive of all areas where this technology can be utilized. With the standardization of a data format, current medical equipment can broadcast relevant information to team members who have subscribed to the data feed on a given patient. In addition, through the customization of data entry forms, healthcare providers can be able to utilize the system 200 to communicate their area of expertise to other members of the team.

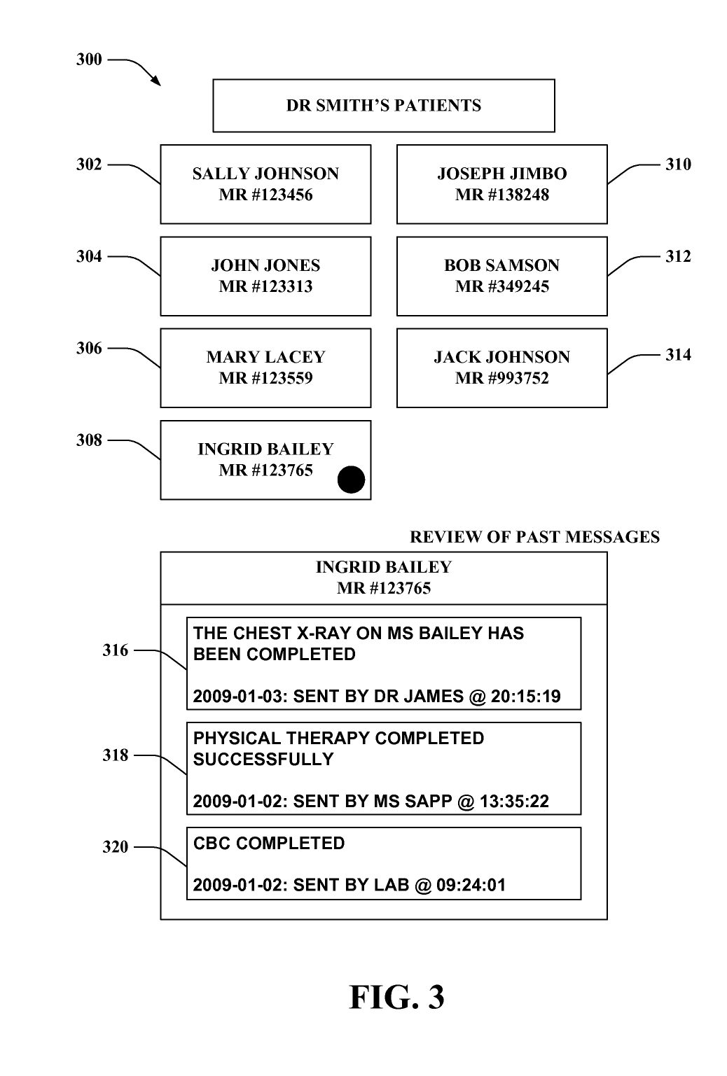

Turning to FIG. 3, illustrated is an example graphical user interface (GUI) 300 that can be employed with the dynamic medical communication techniques described herein. The graphical user interface 300 can be displayed utilizing a subscription component (e.g., one or more of the subscription components 102-104 of FIG. 1, . . . ). Further, the graphical user interface 300 can be associated with a particular subscriber (e.g., Dr. Smith, . . . ). It is to be appreciated that the graphical user interface 300 is presented as an example, and the claimed subject matter is not so limited.

As depicted, the graphical user interface 300 can include icons 302-314 that identify patients subscribed to by the subscriber (e.g., patients added to the subscriber's account, . . . ). Pursuant to the example shown, Dr. Smith can be subscribed to Sally Johnson (icon 302), John Jones (icon 304), Mary Lacey (icon 306), Ingrid Bailey (icon 308), Joseph Jimbo (icon 310), Bob Samson (icon 312), and Jack Johnson (icon 314). Further, each of the icons 302-314 can include a name of the patient, a medical record number corresponding to the patient, and/or any other patient identification information. By way of example, the patient identification information can be a picture of the patient; however, the claimed subject matter is not so limited.

Moreover, the graphical user interface 300 can include past messages. For instance, a particular patient can be selected from the icons 302-314, and past messages pertaining to the particular patient (or a subset thereof) can be rendered as part of the graphical user interface 300. The illustrated example shows the icon 308 corresponding to patient Ingrid Bailey being selected. Thus, past messages 316-320 related to Ingrid Bailey can be displayed via the graphical user interface 300. The past messages 316-320 can each include the content of the message, a time stamp specifying when the message was sent, a source of the message (e.g., identifying a sending healthcare professional and/or a message source component such as one of the message source components 106-108 of FIG. 1, . . . ), and so forth.

Although not depicted, it is further contemplated that message(s) can be sent using the graphical user interface 300. For example, the graphical user interface 300 can include a field in which a patient related message can be inputted (e.g., typed, chosen from a set of preset messages, . . . ), a “send” button (or the like), and so forth. According to an illustration, the patient related message can be a physician order in response to a lab result; however, the claimed subject matter is not so limited. Additionally or alternatively, the graphical user interface 300 can include an association component (not shown) that can be utilized to subscribe to a patient. For instance, the association component can be leveraged to browse and/or search for a given patient to which a subscriber desires to subscribe (e.g., a patient registered in the server 202 of FIG. 2, . . . ). By way of another example, the association component can allow for the subscriber to directly subscribe (and/or unsubscribe) to a particular patient by entering a name, medical record number, a combination thereof, and so forth of the particular patient. Further, the graphical user interface 300 can include an organization component (not shown) that can automatically and/or manually arrange, restructure, etc. message streams corresponding to subscribed to patients. For instance, the organization component can rearrange how message streams are presented as part of the graphical user interface 300 with respect to each other (e.g., relative locations, sizes, colors, . . . ). By way of another illustration, the organization component can prune one or more messages from a message stream (e.g., leveraging a search engine component (not shown), . . . ). The claimed subject matter, however, is not limited to the aforementioned examples.

For example, the graphical user interface 300 can be rendered and can provide a subscriber (e.g., a user, . . . ) with a region or means to load, import, read, etc., data, and can include a region to present the results of such. These regions can comprise known text and/or graphic regions comprising dialogue boxes, static controls, drop-down-menus, list boxes, pop-up menus, edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

The user can also interact with the regions to select and provide information via various input component(s) (not shown) such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

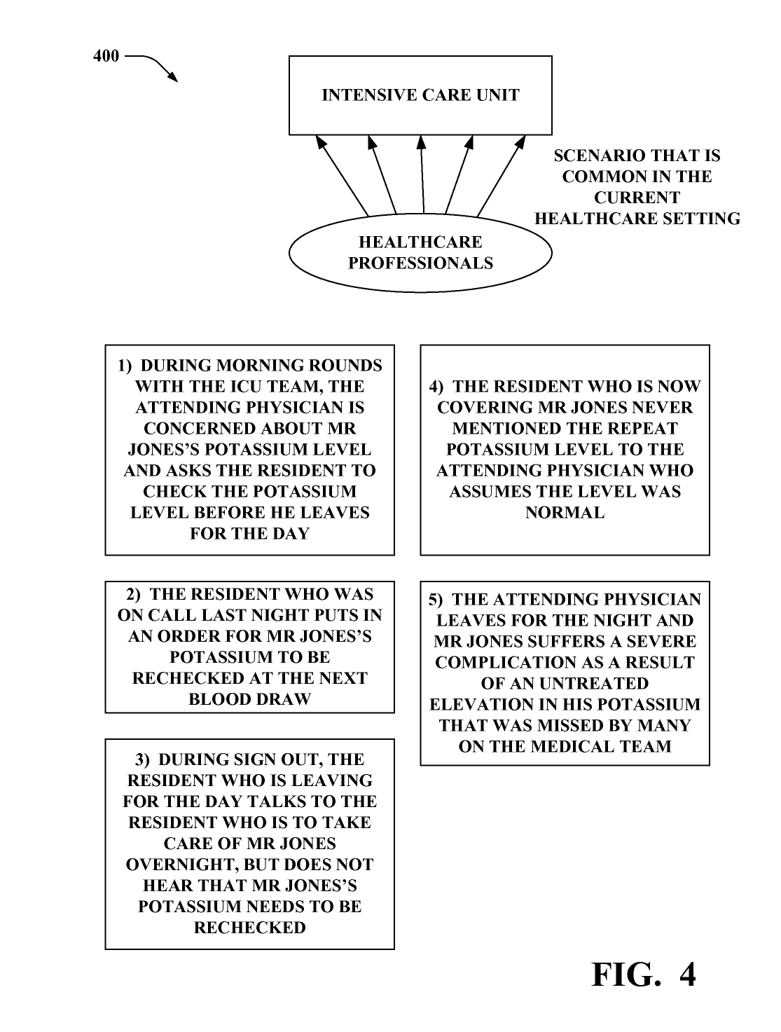

With reference to FIG. 4, illustrated is an example scenario 400 that can result within the current healthcare setting without dynamic medical communication as described herein. The scenario 400 is merely presented as an example, and the claimed subject matter is not so limited. The scenario 400 proceeds as follows. 1) During morning rounds with the ICU team, the attending physician is concerned about Mr. Jones's potassium level and asks the resident to check the potassium level before he leaves for the day. 2) The resident who was on call last night puts in an order for Mr. Jones's potassium to be rechecked at the next blood draw. 3) During sign out, the resident who is leaving for the day talks to the resident who is to take care of Mr. Jones overnight, but does not hear that Mr. Jones's potassium needs to be rechecked. 4) The resident who is now covering Mr. Jones never mentioned the repeat potassium level to the attending physician who assumes the level was normal. 5) The attending physician leaves for the night and Mr. Jones suffers a severe complication as a result of an untreated elevation in his potassium that was missed by many on the medical team.

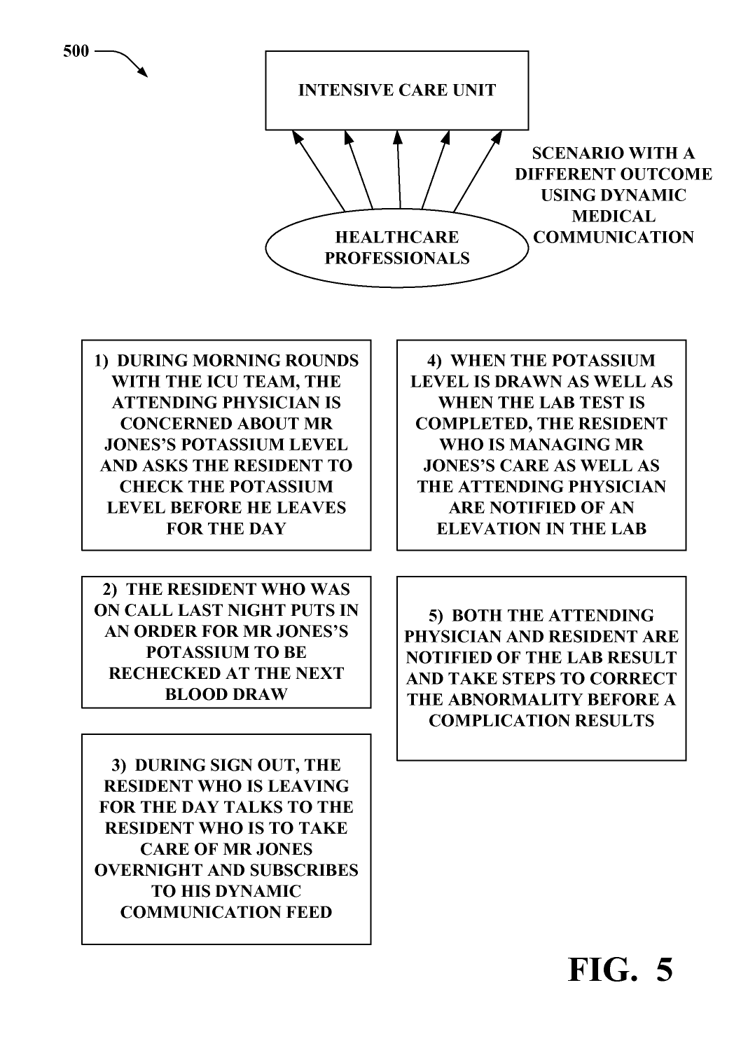

Now turning to FIG. 5, illustrated is an example scenario 500 that can yield a different outcome as compared to traditional techniques using dynamic medical communication. The scenario 500 is merely presented as an example, and the claimed subject matter is not so limited. The scenario 500 can include the following. 1) During morning rounds with the ICU team, the attending physician is concerned about Mr. Jones's potassium level and asks the resident to check the potassium level before he leaves for the day. 2) The resident who was on call last night puts in an order for Mr. Jones's potassium to be rechecked at the next blood draw. 3) During sign out, the resident who is leaving for the day talks to the resident who is to take care of Mr. Jones overnight and subscribes to his dynamic communication feed. 4) When the potassium level is drawn as well as when the lab test is completed, the resident who is managing Mr. Jones's care as well as the attending physician are notified of an elevation in the lab. 5) Both the attending physician and the resident are notified of the lab result and take steps to correct the abnormality before a complication results. Pursuant to the scenario 500, when the resident puts in the order for Mr. Jones's potassium to be rechecked, a message can be disseminated to all of Mr. Jones's subscribers; hence, if the potassium were to go unchecked, and thus no follow-up message(s) indicating that the test was completed or providing the lab results was broadcast, the subscribers can clearly recognize that the test failed to be performed. Accordingly, detrimental results stemming from lack of communication exhibited in scenario 400 of FIG. 4 can be mitigated.

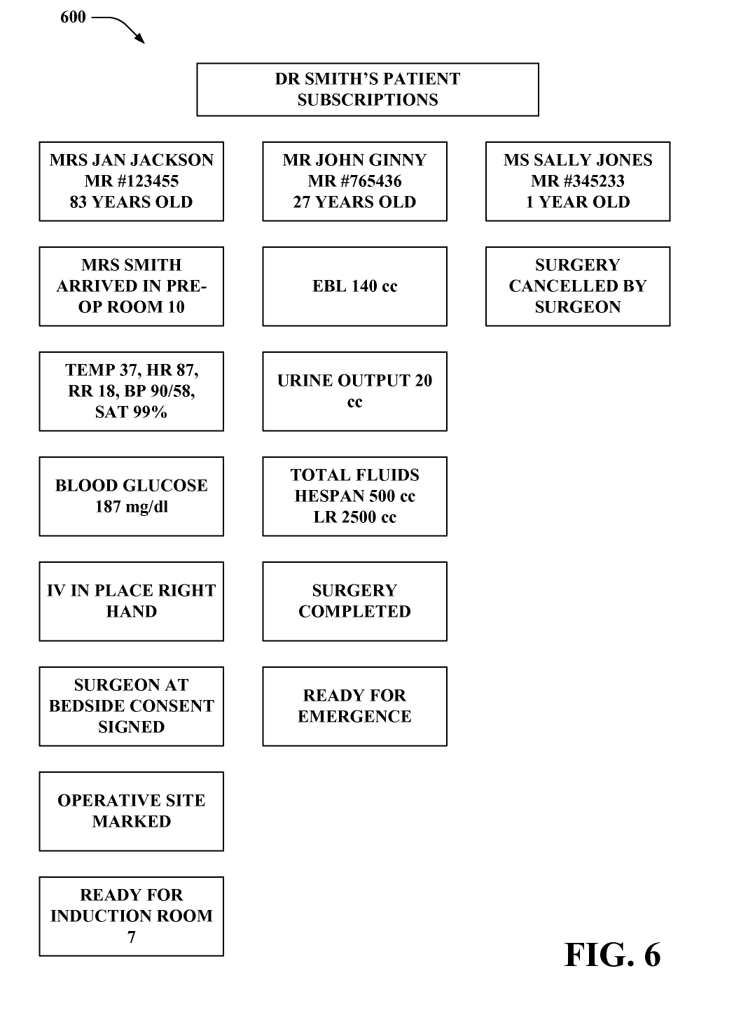

Referring to FIG. 6, illustrated is an example graphical user interface 600 that can be leveraged in an operating room with the dynamic medical communication techniques described herein. The graphical user interface 600 can be displayed employing a subscription component (e.g., one or more of the subscription components 102-104 of FIG. 1, . . . ). Further, the graphical user interface 600 can be associated with a particular subscriber (e.g., Dr. Smith, . . . ). It is to be appreciated that the graphical user interface 600 is presented as an example, and the claimed subject matter is not so limited.

According to an illustration, the graphical user interface 600 can be rendered upon a monitor located within an operating room. It is contemplated that substantially any type of display can be utilized to present the graphical user interface 600. For instance, Dr. Smith can sign in to her account utilizing a device (e.g., associated with the monitor, . . . ) positioned within the operating room, and the graphical user interface 600 can be rendered.

The graphical user interface 600 can include substantially any number of message streams, each related to a respective patient to which the subscriber is subscribed. As depicted in the example 600, three message streams can be included in the graphical user interface 600; however, the claimed subject matter is not so limited. Each message stream can include patient related messages published pertaining to a given patient. As illustrated, a first message stream can be associated with a first patient (e.g., Mrs. Jan Jackson, . . . ), a second message stream can be associated with a second patient (e.g., Mr. John Ginny, . . . ), and a third message stream can be associated with a third patient (e.g., Ms. Sally Jones, . . . ).

Message streams can be differentiated in the graphical user interface 600 in substantially any manner. For instance, message(s) included in a particular message stream can be rendered within a common column as part of the graphical user interface 600. Thus, as shown, messages pertaining to Mrs. Jan Jackson can be positioned within a column. Further, newer messages within the message stream can be added at the bottom of the column. Although not shown, it is contemplated that the messages within a particular message stream can be scrolled through. It is to be appreciated, however, that any differing configuration can be utilized for the graphical user interface 600, and the claimed subject matter is not limited to the foregoing.

By way of another example, messages can be color coded in the graphical user interface 600 as a function of message stream (e.g., associated patient, . . . ). Thus, message(s) pertaining to a first patient can be displayed in a first color, message(s) pertaining to a second patient can be displayed in a second color, and so forth. Pursuant to another example, any other characteristics of the messages can be defined as a function of message stream; these characteristics can include, but are not limited to, pattern, intensity, size, shape, and the like utilized when rendering the message as part of the graphical user interface 600. The claimed subject matter, however, is not limited to these examples.

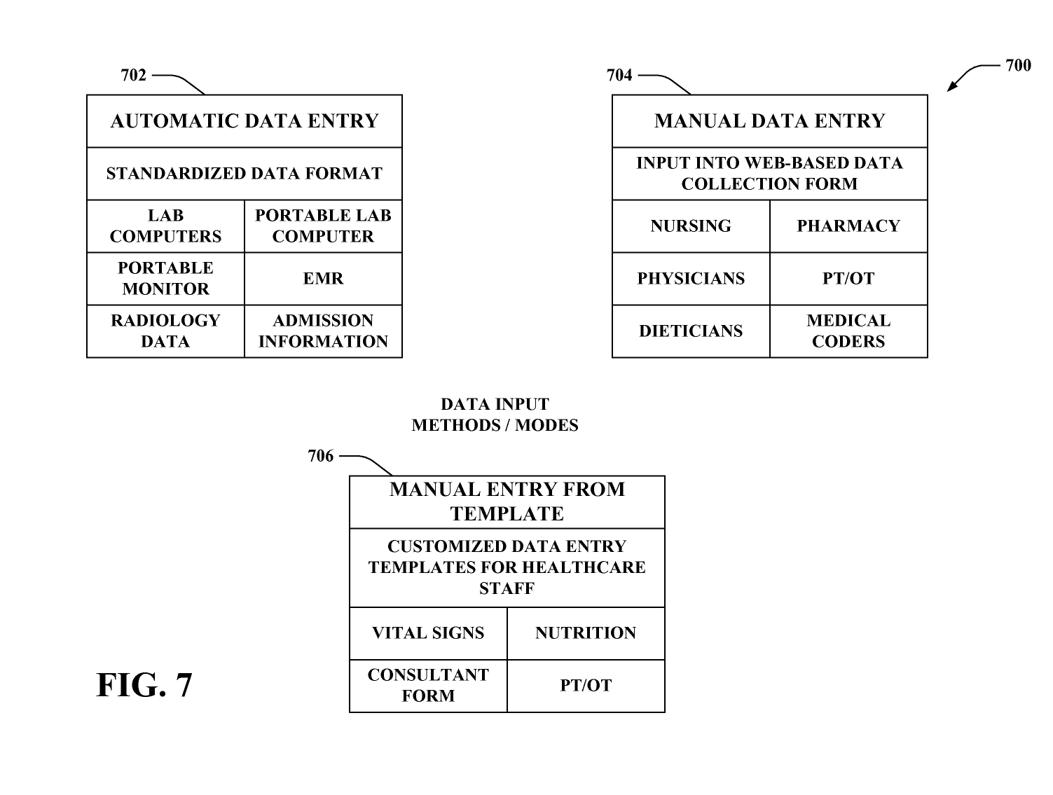

Referring to FIG. 7, illustrated are example data input modes 700 that can be used for data entry into a dynamic medical communicator database. The claimed subject matter, however, is not limited to the examples depicted in FIG. 7. According to an example, an automatic data entry mode 702 can be leveraged. The automatic data entry mode 702 can include a standardized data format. Further, the automatic data entry mode 702 can be used in connection with a lab computer, a portable monitor, radiology data, a portable lab computer, an electronic medical record (EMR), admission information, and so forth.

Pursuant to another example, a manual data entry mode 704 can be utilized, where data can be inputted into a web-based data collection form. The manual data entry mode 704, for instance, can be utilized by nurses, physicians, dieticians, pharmacists, PT/OT, medical coders, and the like.

By way of a further example, a manual entry from a template mode 706 can be leveraged with the dynamic medical communication techniques described herein. The manual entry from a template mode 706 can employ customized data entry templates for healthcare staff. For instance, the mode 706 can be used in connection with collecting vital signs, nutrition information, consultant forms, PT/OT observations, and so forth.

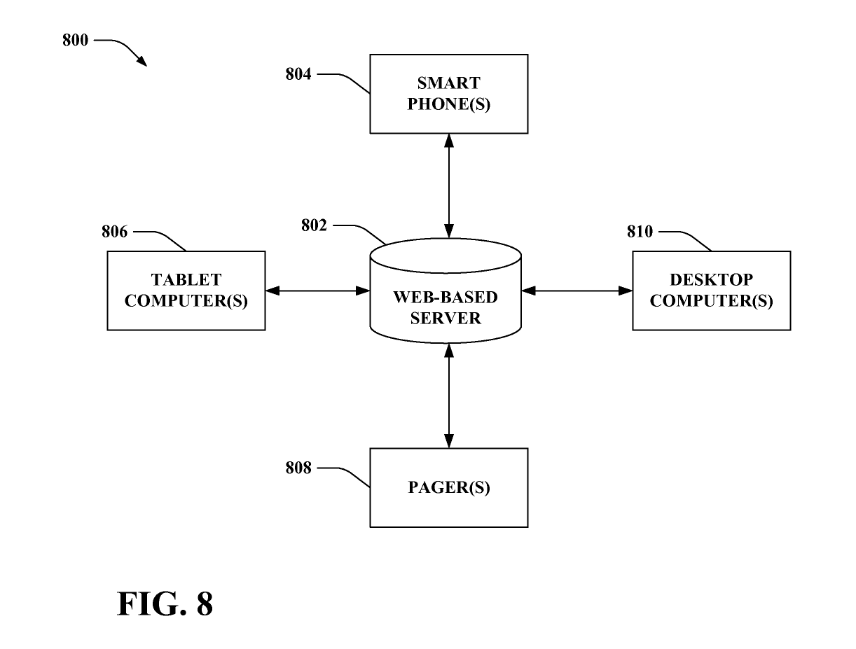

Now turning to FIG. 8, illustrated is an example system 800 that incorporates dynamic medical communication. The system 800 can include a web-based server 802 (e.g., the server 202 of FIG. 2, . . . ). The web-based server 802 can communicate (e.g., via wired connections, wireless connections, combination of wired and wireless connections, . . . ) with various components (e.g., subscription components, message source components, . . . ). By way of example, as shown, the web-based server 802 can send data to and/or receive data from smart phone(s) 804, tablet computer(s) 806, pager(s) 808, and/or desktop computer(s) 810. Additionally or alternatively, the web-based server 802 can exchange data with cellular phone(s), laptop(s), handheld communication device(s), handheld computing device(s), global positioning system(s), personal digital assistant(s) (PDA(s)), and/or any other suitable device(s).

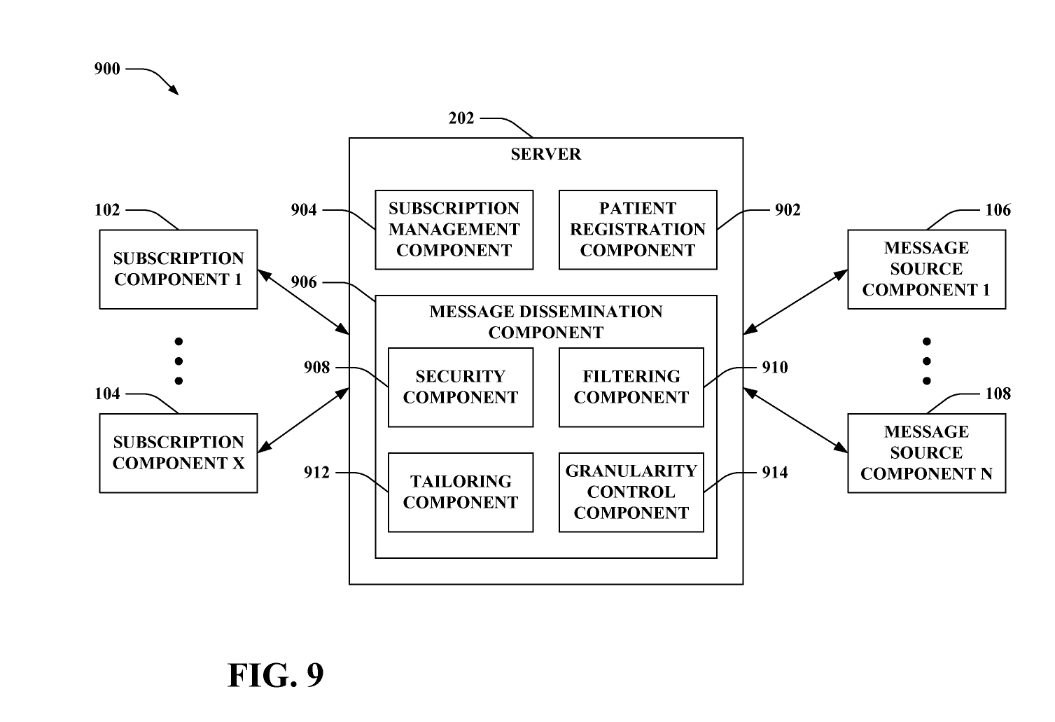

Referring to FIG. 9, illustrated is an example system 900 that provides dynamic, distributive, web-based communication for use in a healthcare setting. The system 900 can include any number of subscription components 102-104 and any number of message source components 106-108. Further, the message source components 106-108 can include the subscription components 102-104 (or a subset thereof); however, the claimed subject matter is not so limited. The system 900 can also include the server 202. The server 202 can receive patient related messages from the message source components 106-108. Further, the server 202 can broadcast the patient related messages to the subscription components 102-104.

The server 202 can further include a patient registration component 902 that can manually, automatically, a combination thereof, etc. enroll patients. Upon being enrolled by the patient registration component 902, a particular patient can be an object to which one or more of the subscription components 102-104 can subscribe (e.g., an object corresponding to the particular patient can be generated by the patient registration component 902, . . . ). For instance, the patient registration component 902 can collect patient related information (e.g., name, date of birth, medical record number, any other identification information, . . . ) and associate such information with the yielded object. According to various examples, the patient registration component 902 can enroll (e.g., automatically, manually, a combination thereof, . . . ) a patient upon the patient being admitted to a hospital, scheduling an appointment, creating a patient account, being born, moving into geographic proximity of a hospital, placing a call to a hospital/healthcare professional (e.g., caller ID information can be automatically obtained by the patient registration component 902 to enroll a patient, . . . ), and so forth.

Moreover, the server 202 can include a subscription management component 904 that controls subscribing and unsubscribing subscription components 102-104 to patients. For instance, the subscription management component 904 can receive requests from subscription component(s) 102-104 for subscribing/unsubscribing to patient(s). According to another illustration, the subscription management component 904 can automatically subscribe and/or unsubscribe subscription component(s) 102-104 to patients. By way of example, if Pete Langhorne is admitted to an emergency room, then the subscription management component 904 can automatically subscribe subscription component(s) 102-104 associated with physician(s), nurse(s), medical coder(s), and the like that correspond to Pete Langhorne (e.g., treat, assist, evaluate, consult, care for, etc. Pete Langhorne, . . . ) and/or the emergency room in general. The claimed subject matter, however, is not so limited.

The subscription management component 904 can add patients to accounts associated with subscription component 102-104. For instance, the subscription management component 904 can add patient(s) to an account by individual selection. According to another example, the subscription management component 904 can include patient(s) in an account as a group by physician (e.g., patients admitted under a particular physician, . . . ). Additionally or alternatively, the subscription management component 904 can include patient(s) in an account as a group by service. Further, the subscription management component 904 can associate patient(s) with an account by assignment (e.g., nurse's current patient load, . . . ). Moreover, the subscription management component 904 can add patient(s) to an account by location (e.g., patients in Ward 2b, . . . ). By way of another illustration, the subscription management component 904 can add patient(s) to an account by procedure (e.g., patients with a certain lab, x-ray data, or the like, . . . ). Further, the subscription management component 904 can associate patient(s) with an account based upon device (e.g., patients with a particular implant, . . . ). It is to be appreciated, however, that the claimed subject matter is not limited to the foregoing examples, and instead, contemplate adding patients to accounts by substantially any manner.

The server 202 can also include a message dissemination component 906 that broadcasts patient related messages obtained from message source components 106-108 to subscription components 102-104 respectively subscribed to patients as maintained by the subscription management component 904. According to an example, the patient related messages can be published, broadcast, etc. by the message dissemination component 906 utilizing Short Message Service (SMS); however, any other protocols, services, and the like can be utilized by the message dissemination component 906 and are intended to fall within the scope of the heretoappended claims. Further, it is contemplated that a patient related message can be pushed to the subscription component 102-104 by employing a plurality of services, protocols, and so forth, for instance.

The message dissemination component 906 can further include a security component 908, a filtering component 910, a tailoring component 912, and/or a granularity control component 914. The security component 908 can encrypt the broadcasted patient related messages. For instance, different levels of encryption can be utilized by the security component 908 as a function of the nature of the message (e.g., stronger encryption can be applied to a message that includes a patient's diagnosis as compared to a message that indicates a patient has arrived at a healthcare professional's office, . . . ). According to another example, the security component 908 can evaluate credentials associated with the subscription component 102-104 prior to sending patient related messages to such recipient.

The filtering component 910 can filter patient related messages being sent. For instance, the filtering component 910 can restrict certain messages from being broadcast to particular subscription components 102-104. According to an illustration, the filtering component 910 can filter messages sent to a family member of a patient; thus, messages that indicate that the patient is out of the operating room, test results have been returned, etc. can be transmitted to the family member of the patient, while messages including lab results can be withheld from the family member of the patient (e.g., the messages including lab results can be provided to physicians, nurses, other healthcare professionals, etc. subscribed to the patient, . . . ). By way of further illustration, the filtering component 910 can restrict messages that indicate a patient has passed away, has been diagnosed with a serious condition, etc. from being sent to a family member of a patient or a patient (subscribed to his own message stream); therefore, a healthcare professional can convey such information to the family member or patient, rather than the family member or patient receiving grave information via the system 900.

Moreover, the tailoring component 912 can personalize the patient related messages. The tailoring component 912 can personalize the messages as a function of the message source component 106-108 from which the messages respectively originate, the subscription component 102-104 to which the messages respectively will be sent, and so forth.

The granularity control component 914 can manage the content of the messages based upon various considerations. The granularity control component 914 can adjust the content of the messages (and/or restrict the message dissemination component 906 from transferring one or more messages by leveraging the filtering component 910) for one subscription component 102-104, a subset of the subscription component 102-104, all subscription components 102-104, etc. subscribed to a given patient. Thus, richer data (e.g., video, images, . . . ) can be selected or deselected for sending. The granularity control component 914, for instance, can consider processor speed, memory, cache size, amount of available cache, transmission type, transmission speed, proximity to patient, form factor of receiving device/display, subscriber's schedule, how critical the patient's condition is, transmission cost, number of subscribed to patients, number of subscription components 102-104 subscribed to the patient, and so forth when generating the messages for transmission. The claimed subject matter, however, is not so limited.

The system 900 can further include an intelligent component (not shown) that can be employed by the server 202. For example, the intelligent component can infer whether to subscribe a particular one of the subscription components 102-104 (e.g., corresponding to a particular user, . . . ) to a given patient. According to another example, the intelligent component can infer a manner by which a message stream can be organized, structured, etc.

It is to be understood that the intelligent component can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

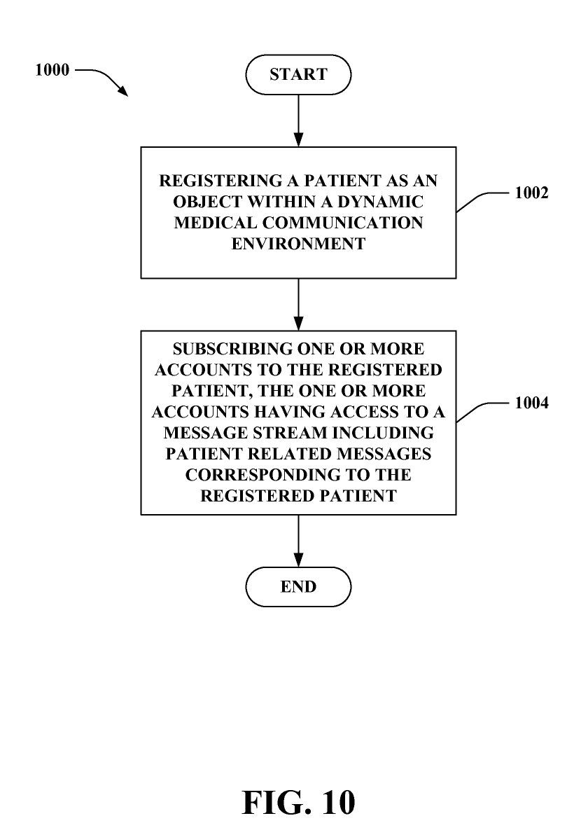

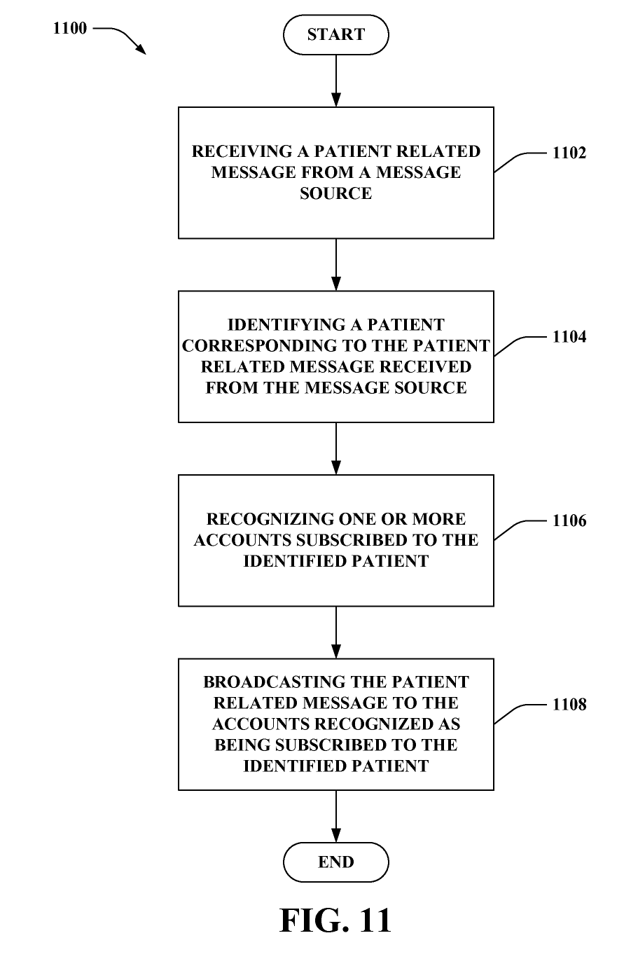

FIGS. 10-11 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events.

Referring to FIG. 10, illustrated is a methodology 1000 that facilitates initializing a patient within a dynamic medical communication environment. At 1002, a patient can be registered as an object with a dynamic medical communication environment. The patient can be registered automatically, manually, a combination thereof, and so forth. At 1004, one or more accounts can subscribe to the registered patient, the one or more accounts having access to a message stream including patient related messages corresponding to the registered patient. The one or more accounts can be automatically, manually, a combination thereof, etc. subscribed to the registered patient. According to various examples, the one or more accounts can subscribe to the registered patient by individual selection, as a group (e.g., by physician, service, . . . ), by assignment (e.g., to a healthcare provider, . . . ), by location, by procedure, by device, a combination thereof, and so forth.

Turning to FIG. 11, illustrated is a methodology 1100 that facilitates publishing patient related messages within a dynamic medical communication environment. At 1102, a patient related message can be received from a message source. At 1104, a patient corresponding to the patient related message received from the message source can be identified. At 1106, one or more accounts subscribed to the identified patient can be recognized. At 1108, the patient related message can be broadcast to the accounts recognized as being subscribed to the identified patient.

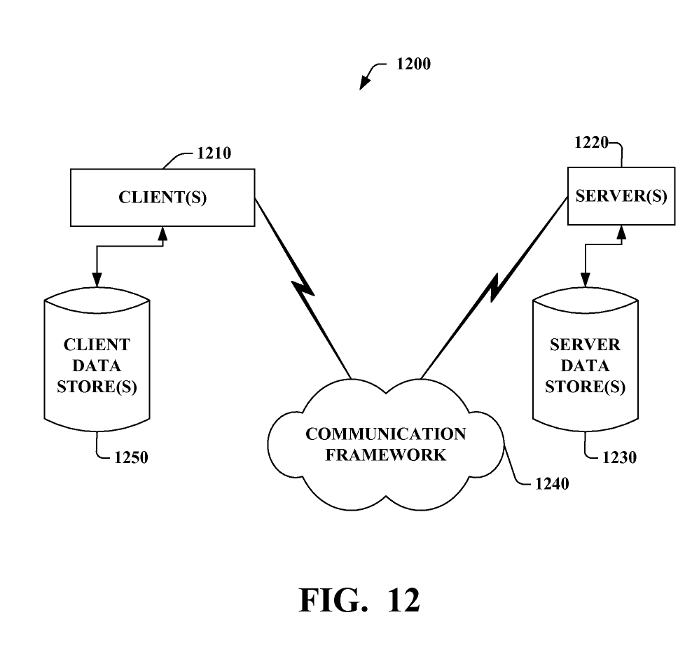

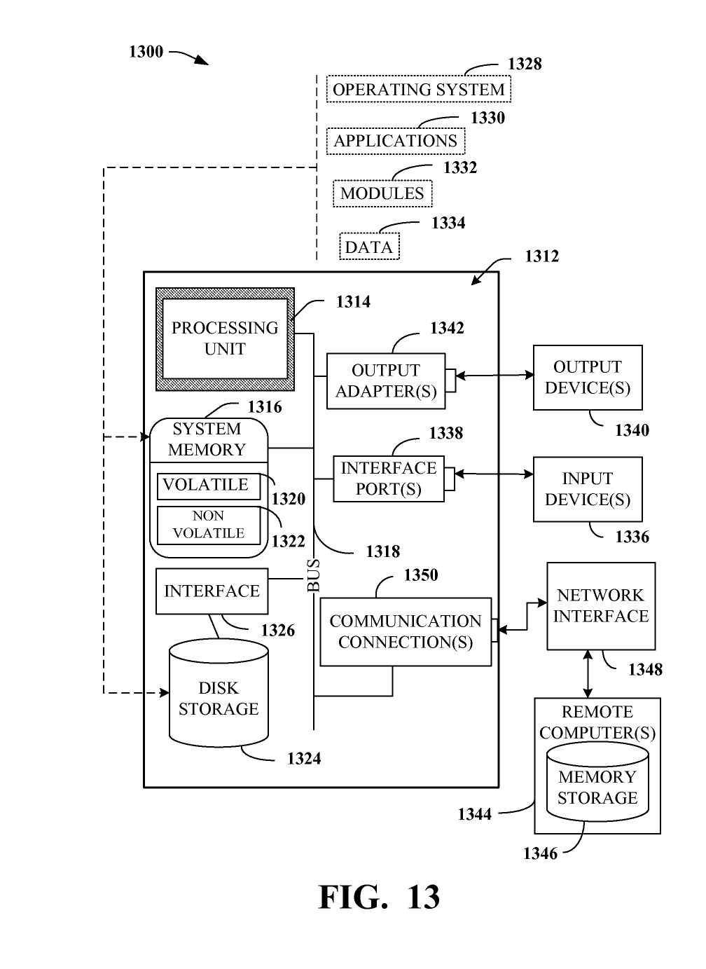

In order to provide additional context for implementing various aspects of the claimed subject matter, FIGS. 12-13 and the following discussion is intended to provide a brief, general description of a suitable computing environment in which the various aspects of the subject innovation may be implemented. For instance, FIGS. 12-13 set forth a suitable computing environment that can be employed in connection with employing dynamic medical communication systems and/or methods. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 12 is a schematic block diagram of a sample-computing environment 1200 with which the claimed subject matter can interact. The system 1200 includes one or more client(s) 1210. The client(s) 1210 can be hardware and/or software (e.g., threads, processes, computing devices). The system 1200 also includes one or more server(s) 1220. The server(s) 1220 can be hardware and/or software (e.g., threads, processes, computing devices). The servers 1220 can house threads to perform transformations by employing the subject innovation, for example.

One possible communication between a client 1210 and a server 1220 can be in the form of a data packet adapted to be transmitted between two or more computer processes. The system 1200 includes a communication framework 1240 that can be employed to facilitate communications between the client(s) 1210 and the server(s) 1220. The client(s) 1210 are operably connected to one or more client data store(s) 1250 that can be employed to store information local to the client(s) 1210. Similarly, the server(s) 1220 are operably connected to one or more server data store(s) 1230 that can be employed to store information local to the servers 1220.

With reference to FIG. 13, an exemplary environment 1300 for implementing various aspects of the claimed subject matter includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), or flash memory. Volatile memory 1320 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also includes removable/non-removable, volatile/non-volatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in the suitable operating environment 1300. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the claimed subject matter can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system, comprising:
a server that receives patient related messages from one or more message source components and broadcasts the patient related messages to one or more subscription components as a function of identities of patients respectively corresponding to the patient related messages.

2. The system of claim 1, the server further comprises a patient registration component that enrolls patients as objects to which one or more subscription components subscribe.

3. The system of claim 1, the server further comprises a subscription management component that controls subscribing and unsubscribing subscription components to patients.

4. The system of claim 3, the subscription management component subscribes subscription components to patients based upon one or more of individual selection, as a group, by assignment, by location, by procedure, or by device.

5. The system of claim 3, the server further comprises a message dissemination component that broadcasts the patient related messages to the one or more subscription components respectively subscribed to patients as maintained by the subscription management component.

6. The system of claim 5, the message dissemination component further comprises a security component that encrypts the broadcasted patient related messages.

7. The system of claim 5, the message dissemination component further comprises a filtering component that restricts a subset of the patient related messages from being sent to a subset of the one or more subscription components.

8. The system of claim 5, the message dissemination component further comprises a tailoring component that personalizes the patient related messages.

9. The system of claim 5, the message dissemination component further comprises a granularity control component that manages the content of the patient related messages.

10. The system of claim 1, the patient related messages being broadcast to the one or more subscription components utilizing Short Message Service (SMS).

11. The system of claim 1, the patient related messages being broadcast to the one or more subscription components for rendering as part of graphical user interfaces respectively corresponding to the one or more subscription components.

12. The system of claim 1, the patient related messages corresponding to a common patient being sent as part of a same message stream.

13. The system of claim 1, the one or more subscription components including at least one of an account, a tablet computer, a smart phone, a desktop component, a pager, a cellular phone, a laptop, a display, a handheld communication device, a handheld computing device, a global positioning system, or a personal digital assistant.

14. A method that facilitates initializing a patient within a dynamic medical communication environment, comprising:
registering a patient as an object within a dynamic medical communication environment; and
subscribing one or more accounts to the registered patient, the one or more accounts having access to a message stream including patient related messages corresponding to the registered patient.

15. The method of claim 14, further comprising registering the patient based upon manually entered information.

16. The method of claim 14, further comprising registering the patient by integrating with a patient management system of a hospital.

17. The method of claim 14, further comprising subscribing the one or more accounts to the registered patient by one or more of individual selection, as a group, by assignment, by location, by procedure, or by device.

18. The method of claim 14, further comprising transmitting the patient related messages corresponding to the registered patient in the message stream to the one or more accounts subscribed thereto.

19. The method of claim 18, the transmitted patient related messages rendered using subscription components associated with the one or more accounts.

20. A method that facilitates publishing patient related messages within a dynamic medical communication environment, comprising:
receiving a patient related message from a message source;
identifying a patient corresponding to the patient related message received from the message source;
recognizing one or more accounts subscribed to the identified patient; and
broadcasting the patient related message to the accounts recognized as being subscribed to the identified patient.
